(19) United States
(12) Patent Application Publication
(10) Pub. No.: US 2025/0053457 A1
(43) Pub. Date: Feb. 13, 2025

(54) System, Method, and Computer Program Product for Dynamically Processing Model Inference or Training Requests

(71) Applicant: Visa International Service Association, San Francisco, CA (US)

(72) Inventors: Mingji Lou, Cedar Park, TX (US); Peng Peng, San Francisco, CA (US); Victor James Genty, Austin, TX (US); Niranjan Dashrath Jadhav, Leander, TX (US); Ningyu Shi, Austin, TX (US); Runxin He, Cedar Park, TX (US); Yu Gu, Austin, TX (US); James M. Gordon, Moraga, CA (US); Ajay Raman Rayapati, Georgetown, TX (US); Junjun Yu, Austin, TX (US)

(21) Appl. No.: 18/795,732

(22) Filed: Aug. 6, 2024

Related U.S. Application Data
(60) Provisional application No. 63/531,052, filed on Aug. 7, 2023.

(51) Int. Cl. G06F 9/50; G06F 9/455

(52) U.S. Cl. CPC G06F 9/5044; G06F 9/45558; G06F 2009/45562; G06F 2209/504

(57) ABSTRACT

Systems, methods, and computer program products are provided for dynamically processing model inference or training requests. A system may include at least one processor to receive a plurality of requests from a plurality of requesting systems, create a plurality of instantiations of at least one machine-learning model based on the plurality of requests and service data associated with each requesting system of the plurality of requesting systems, stream data associated with at least one request of the plurality of requests to each instantiation of the plurality of instantiations, adjust a rate limit for each instantiation of the plurality of instantiations based on the service data associated with at least one requesting system related to a respective instantiation, resulting in an adjusted rate limit, and process at least one request of the plurality of requests with an instantiation of the plurality of instantiations based on the adjusted rate limit.

### CROSS REFERENCE TO RELATED APPLICATION

This application claims priority to U.S. Provisional Patent Application No. 63/531,052 filed on Aug. 7, 2023, the disclosure of which is hereby incorporated by reference in its entirety.

### BACKGROUND

### 1. Technical Field

The present disclosure relates generally to the use of machine learning models and, in some non-limiting embodiments or aspects, to systems, methods, and computer program products for dynamically processing model inference or training requests.

### 2. Technical Considerations

Cloud computing may refer to the on-demand availability of computer system resources, including data storage (e.g., cloud storage) and/or computing power, without direct, active management by the user of the computer system resources. In some instances, large clouds may have functions distributed over multiple locations, for example, where each of the locations is a data center. Machine learning as a service (MLaaS) may refer to a range of machine learning tools that are offered as services from cloud computing providers.

However, systems for executing MLaaS may require the use of a significant amount of computational resources to handle different models and/or different consumers. In addition, the use of processing and memory resources may vary among different models and/or different consumers of the data. With this, rate limits and/or resource allocations may not be uniformly applied to all models and/or consumers, such as those in a shared queue, which may lead to degrading performance.

### SUMMARY

Accordingly, provided are improved systems, methods, and computer program products for dynamically processing model inference or training requests.

According to some non-limiting embodiments or aspects, provided is a system for dynamically processing model inference or training requests. In some non-limiting embodiments or aspects, the system may include at least one processor. In some non-limiting embodiments or aspects, the at least one processor may be configured to receive a plurality of requests from a plurality of requesting systems. In some non-limiting embodiments or aspects, the at least one processor may be configured to create a plurality of instantiations of at least one machine learning model based on the plurality of requests and service data associated with each requesting system of the plurality of requesting systems. In some non-limiting embodiments or aspects, the at least one processor may be configured to stream data associated with at least one request of the plurality of requests to each instantiation of the plurality of instantiations. In some non-limiting embodiments or aspects, the at least one processor may be configured to adjust a rate limit for each instantiation of the plurality of instantiations based on the service data associated with at least one requesting system related to a respective instantiation, resulting in an adjusted rate limit. In some non-limiting embodiments or aspects, the at least one processor may be configured to process at least one request of the plurality of requests with an instantiation of the plurality of instantiations based on the adjusted rate limit.

In some non-limiting embodiments or aspects, the service data may include at least one parameter of a service level agreement (SLA) stored in a data storage device in association with each requesting system.

In some non-limiting embodiments or aspects, the at least one parameter may include a reporting frequency, and when adjusting the rate limit for each instantiation of the plurality of instantiations based on the service data associated with the at least one requesting system associated with the instantiation, the at least one processor may be configured to adjust the rate limit to a higher or lower rate limit based on the reporting frequency.

In some non-limiting embodiments or aspects, the at least one processor may be further configured to determine whether to store the data associated with the at least one request in a hard disk storage unit or in memory based on the service data. In some non-limiting embodiments or aspects, the at least one processor may be further configured to store the data associated with the at least one request based on the determination.

In some non-limiting embodiments or aspects, when determining whether to store the data associated with the at least one request in the hard disk storage unit or in the memory, the at least one processor may be configured to determine whether to store the data associated with the at least one request in the hard disk storage unit or in the memory based on a reporting frequency parameter of the service data, such that a reporting frequency that satisfies a temporal threshold is stored in the hard disk storage unit.

In some non-limiting embodiments or aspects, the at least one machine learning model may include a fraud scoring model, and the plurality of requesting systems may include a plurality of issuer systems.

In some non-limiting embodiments or aspects, when receiving the plurality of requests from the plurality of requesting systems, the at least one processor may be configured to receive a plurality of inference or training requests from the plurality of requesting systems to be processed using the at least one machine learning model.

According to some non-limiting embodiments or aspects, provided is a computer-implemented method for dynamically processing model inference or training requests. In some non-limiting embodiments or aspects, the computer-implemented method may include receiving, with at least one processor, a plurality of requests from a plurality of requesting systems. In some non-limiting embodiments or aspects, the computer-implemented method may include creating, with at least one processor, a plurality of instantiations of at least one machine learning model based on the plurality of requests and service data associated with each requesting system of the plurality of requesting systems. In some non-limiting embodiments or aspects, the computer-implemented method may include streaming, with at least one processor, data associated with at least one inference request of the plurality of requests to each instantiation of the plurality of instantiations. In some non-limiting embodiments or aspects, the computer-implemented method may include adjusting, with at least one processor, a rate limit for each instantiation of the plurality of instantiations based on the service data associated with at least one requesting system associated with the instantiation, resulting in an adjusted rate limit. In some non-limiting embodiments or aspects, the computer-implemented method may include processing, with at least one processor, at least one request of the plurality of requests with an instantiation of the plurality of instantiations based on the adjusted rate limit.

In some non-limiting embodiments or aspects, the service data may include at least one parameter of a service level agreement (SLA) stored in a data storage device in association with each requesting system.

In some non-limiting embodiments or aspects, the at least one parameter may include a reporting frequency, and adjusting the rate limit for each instantiation of the plurality of instantiations based on the service data associated with the at least one requesting system associated with the instantiation may include adjusting the rate limit to a higher or lower rate limit based on the reporting frequency.

In some non-limiting embodiments or aspects, the computer-implemented method may include determining whether to store the data associated with the at least one request in a hard disk storage unit or in memory based on the service data. In some non-limiting embodiments or aspects, the computer-implemented method may include storing the data associated with the at least one request based on the determination.

In some non-limiting embodiments or aspects, determining whether to store the data associated with the at least one request in the hard disk storage unit or in the memory may include determining whether to store the data associated with the at least one request in the hard disk storage unit or in the memory based on a reporting frequency parameter of the service data, such that a reporting frequency that satisfies a temporal threshold is stored in the hard disk storage unit.

In some non-limiting embodiments or aspects, the at least one machine learning model may include a fraud scoring model, and the plurality of requesting systems may include a plurality of issuer systems.

In some non-limiting embodiments or aspects, receiving the plurality of requests from the plurality of requesting systems may include receiving a plurality of inference or training requests from the plurality of requesting systems to be processed using the at least one machine learning model.

According to some non-limiting embodiments or aspects, provided is a computer program product for dynamically processing model inference or training requests. In some non-limiting embodiments or aspects, the computer program product may include at least one non-transitory computer-readable medium including program instructions that, when executed by at least one processor, may cause the at least one processor to receive a plurality of requests from a plurality of requesting systems. In some non-limiting embodiments or aspects, the program instructions may cause the at least one processor to create a plurality of instantiations of at least one machine learning model based on the plurality of requests and service data associated with each requesting system of the plurality of requesting systems. In some non-limiting embodiments or aspects, the program instructions may cause the at least one processor to stream data associated with at least one inference request of the plurality of requests to each instantiation of the plurality of instantiations. In some non-limiting embodiments or aspects, the program instructions may cause the at least one processor to adjust a rate limit for each instantiation of the plurality of instantiations based on the service data associated with at least one requesting system associated with the instantiation, resulting in an adjusted rate limit. In some non-limiting embodiments or aspects, the program instructions may cause the at least one processor to process at least one request of the plurality of requests with an instantiation of the plurality of instantiations based on the adjusted rate limit.

In some non-limiting embodiments or aspects, the service data may include at least one parameter of a service level agreement (SLA) stored in a data storage device in association with each requesting system.

In some non-limiting embodiments or aspects, the at least one parameter may include a reporting frequency, and the program instructions that cause the at least one processor to adjust the rate limit for each instantiation of the plurality of instantiations based on the service data associated with the at least one requesting system associated with the instantiation, may cause the at least one processor to adjust the rate limit to a higher or lower rate limit based on the reporting frequency.

In some non-limiting embodiments or aspects, the program instructions may further cause the at least one processor to determine whether to store the data associated with the at least one request in a hard disk storage unit or in memory based on the service data. In some non-limiting embodiments or aspects, the program instructions may further cause the at least one processor to store the data associated with the at least one request based on the determination.

In some non-limiting embodiments or aspects, the program instructions that cause the at least one processor to determine whether to store the data associated with the at least one request in the hard disk storage unit or in the memory, may cause the at least one processor to determine whether to store the data associated with the at least one request in the hard disk storage unit or in the memory based on a reporting frequency parameter of the service data, such that a reporting frequency that satisfies a temporal threshold is stored in the hard disk storage unit.

In some non-limiting embodiments or aspects, the at least one machine learning model may include a fraud scoring model, and the plurality of requesting systems may include a plurality of issuer systems.

In some non-limiting embodiments or aspects, the program instructions that cause the at least one processor to receive the plurality of requests from the plurality of requesting systems, may cause the at least one processor to receive a plurality of inference or training requests from the plurality of requesting systems to be processed using the at least one machine learning model.

Further non-limiting embodiments or aspects will be set forth in the following numbered clauses:
Clause 1: A system comprising: at least one processor configured to: receive a plurality of requests from a plurality of requesting systems; create a plurality of instantiations of at least one machine learning model based on the plurality of requests and service data associated with each requesting system of the plurality of requesting systems; stream data associated with at least one request of the plurality of requests to each instantiation of the plurality of instantiations; adjust a rate limit for each instantiation of the plurality of instantiations based on the service data associated with at least one requesting system related to a respective instantiation, resulting in an adjusted rate limit; and process at least one request of the plurality of requests with an instantiation of the plurality of instantiations based on the adjusted rate limit.
Clause 2: The system of clause 1, wherein the service data comprises at least one parameter of a service level agreement (SLA) stored in a data storage device in association with each requesting system.
Clause 3: The system of clause 1 or 2, wherein the at least one parameter comprises a reporting frequency, and wherein, when adjusting the rate limit for each instantiation of the plurality of instantiations based on the service data associated with the at least one requesting system associated with the instantiation, the at least one processor is configured to: adjust the rate limit to a higher or lower rate limit based on the reporting frequency.
Clause 4: The system of any of clauses 1-3, wherein the at least one processor is further configured to: determine whether to store the data associated with the at least one request in a hard disk storage unit or in memory based on the service data; and store the data associated with the at least one request based on the determination.
Clause 5: The system of any of clauses 1-4, wherein, when determining whether to store the data associated with the at least one request in the hard disk storage unit or in the memory, the at least one processor is configured to: determine whether to store the data associated with the at least one request in the hard disk storage unit or in the memory based on a reporting frequency parameter of the service data, such that a reporting frequency that satisfies a temporal threshold is stored in the hard disk storage unit.
Clause 6: The system of any of clauses 1-5, wherein the at least one machine learning model comprises a fraud scoring model, and wherein the plurality of requesting systems comprises a plurality of issuer systems.
Clause 7: The system of any of clauses 1-6, wherein, when receiving the plurality of requests from the plurality of requesting systems, the at least one processor is configured to: receive a plurality of inference or training requests from the plurality of requesting systems to be processed using the at least one machine learning model.
Clause 8: A computer-implemented method comprising: receiving, with at least one processor, a plurality of requests from a plurality of requesting systems; creating, with at least one processor, a plurality of instantiations of at least one machine learning model based on the plurality of requests and service data associated with each requesting system of the plurality of requesting systems; streaming, with at least one processor, data associated with at least one inference request of the plurality of requests to each instantiation of the plurality of instantiations; adjusting, with at least one processor, a rate limit for each instantiation of the plurality of instantiations based on the service data associated with at least one requesting system associated with the instantiation, resulting in an adjusted rate limit; and processing, with at least one processor, at least one request of the plurality of requests with an instantiation of the plurality of instantiations based on the adjusted rate limit.
Clause 9: The computer-implemented method of clause 8, wherein the service data comprises at least one parameter of a service level agreement (SLA) stored in a data storage device in association with each requesting system.
Clause 10: The computer-implemented method of clause 8 or 9, wherein the at least one parameter comprises a reporting frequency, and wherein adjusting the rate limit for each instantiation of the plurality of instantiations based on the service data associated with the at least one requesting system associated with the instantiation comprises: adjusting the rate limit to a higher or lower rate limit based on the reporting frequency.
Clause 11: The computer-implemented method of any of clauses 8-10, further comprising: determining whether to store the data associated with the at least one request in a hard disk storage unit or in memory based on the service data; and storing the data associated with the at least one request based on the determination.
Clause 12: The computer-implemented method of any of clauses 8-11, wherein determining whether to store the data associated with the at least one request in the hard disk storage unit or in the memory comprises: determining whether to store the data associated with the at least one request in the hard disk storage unit or in the memory based on a reporting frequency parameter of the service data, such that a reporting frequency that satisfies a temporal threshold is stored in the hard disk storage unit.
Clause 13: The computer-implemented method of any of clauses 8-12, wherein the at least one machine learning model comprises a fraud scoring model, and wherein the plurality of requesting systems comprises a plurality of issuer systems.
Clause 14: The computer-implemented method of any of clauses 8-13, wherein receiving the plurality of requests from the plurality of requesting systems comprises: receiving a plurality of inference or training requests from the plurality of requesting systems to be processed using the at least one machine learning model.
Clause 15: A computer program product comprising at least one non-transitory computer-readable medium including program instructions that, when executed by at least one processor, causes the at least one processor to: receive a plurality of requests from a plurality of requesting systems; create a plurality of instantiations of at least one machine learning model based on the plurality of requests and service data associated with each requesting system of the plurality of requesting systems; stream data associated with at least one inference request of the plurality of requests to each instantiation of the plurality of instantiations; adjust a rate limit for each instantiation of the plurality of instantiations based on the service data associated with at least one requesting system associated with the instantiation, resulting in an adjusted rate limit; and process at least one request of the plurality of requests with an instantiation of the plurality of instantiations based on the adjusted rate limit.
Clause 16: The computer program product of clause 15, wherein the service data comprises at least one parameter of a service level agreement (SLA) stored in a data storage device in association with each requesting system.
Clause 17: The computer program product of clause 15 or 16, wherein the at least one parameter comprises a reporting frequency, and wherein, the program instructions that cause the at least one processor to adjust the rate limit for each instantiation of the plurality of instantiations based on the service data associated with the at least one requesting system associated with the instantiation, cause the at least one processor to: adjust the rate limit to a higher or lower rate limit based on the reporting frequency.
Clause 18: The computer program product of any of clauses 15-17, wherein the program instructions further cause the at least one processor to: determine whether to store the data associated with the at least one request in a hard disk storage unit or in memory based on the service data; and store the data associated with the at least one request based on the determination.
Clause 19: The computer program product of any of clauses 15-18, wherein, the program instructions that cause the at least one processor to determine whether to store the data associated with the at least one request in the hard disk storage unit or in the memory, cause the at least one processor to: determine whether to store the data associated with the at least one request in the hard disk storage unit or in the memory based on a reporting frequency parameter of the service data, such that a reporting frequency that satisfies a temporal threshold is stored in the hard disk storage unit.
Clause 20: The computer program product of any of clauses 15-19, wherein the at least one machine learning model comprises a fraud scoring model, and wherein the plurality of requesting systems comprises a plurality of issuer systems.
Clause 21: The computer program product of any of clauses 15-20, wherein, the program instructions that cause the at least one processor to receive the plurality of requests from the plurality of requesting systems, cause the at least one processor to: receive a plurality of inference or training requests from the plurality of requesting systems to be processed using the at least one machine learning model.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter.

### BRIEF DESCRIPTION OF THE DRAWINGS

Additional advantages and details of the present disclosure are explained in greater detail below with reference to the exemplary embodiments that are illustrated in the accompanying figures, in which:

FIG. 1 is a diagram of a non-limiting embodiment or aspect of an environment in which systems, devices, products, apparatus, and/or methods, described herein, may be implemented, according to the principles of the present disclosure;

FIG. 2 is a flowchart of a non-limiting embodiment or aspect of a process for dynamically processing model inference or training requests;

FIG. 3 is a schematic diagram of an exemplary implementation of a system and/or method for dynamically processing model inference or training requests, according to some non-limiting embodiments or aspects;

FIG. 4 is a diagram of an exemplary environment in which systems, methods, and/or computer program products, described herein, may be implemented, according to some non-limiting embodiments or aspects;

FIG. 5 is a schematic diagram of example components of one or more devices of FIG. 1 and/or FIG. 4, according to some non-limiting embodiments or aspects; and

FIG. 6 is a schematic diagram of an exemplary implementation of a system for dynamically processing model inference or training requests, according to some non-limiting embodiments or aspects.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the embodiments may assume various alternative variations and step sequences, except where expressly specified to the contrary. It is also to be understood that the specific devices and processes illustrated in the attached drawings, and described in the following specification, are simply exemplary embodiments or aspects of the disclosed subject matter. Hence, specific dimensions and other physical characteristics related to the embodiments or aspects disclosed herein are not to be considered as limiting.

Some non-limiting embodiments or aspects may be described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the term “acquirer institution” may refer to an entity licensed and/or approved by a transaction service provider to originate transactions (e.g., payment transactions) using a payment device associated with the transaction service provider. The transactions the acquirer institution may originate may include payment transactions (e.g., purchases, original credit transactions (OCTs), account funding transactions (AFTs), and/or the like). In some non-limiting embodiments or aspects, an acquirer institution may be a financial institution, such as a bank. As used herein, the term “acquirer system” may refer to one or more computing devices operated by or on behalf of an acquirer institution, such as a server computer executing one or more software applications.

As used herein, the term “account identifier” may include one or more primary account numbers (PANs), tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more data structures (e.g., one or more databases, and/or the like) such that they may be used to conduct a transaction without directly using the original account identifier. In some examples, an original account identifier, such as a PAN, may be associated with a plurality of tokens for different individuals or purposes.

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second units. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.”

As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

As used herein, the term “issuer institution” may refer to one or more entities, such as a bank, that provide accounts to customers for conducting transactions (e.g., payment transactions), such as initiating credit and/or debit payments. For example, an issuer institution may provide an account identifier, such as a PAN, to a customer that uniquely identifies one or more accounts associated with that customer. The account identifier may be embodied on a portable financial device, such as a physical financial instrument, e.g., a payment card, and/or may be electronic and used for electronic payments. The term “issuer system” refers to one or more computer devices operated by or on behalf of an issuer institution, such as a server computer executing one or more software applications. For example, an issuer system may include one or more authorization servers for authorizing a transaction.

As used herein, the term “merchant” may refer to an individual or entity that provides goods and/or services, or access to goods and/or services, to customers based on a transaction, such as a payment transaction. The term “merchant” or “merchant system” may also refer to one or more computer systems operated by or on behalf of a merchant, such as a server computer executing one or more software applications.

As used herein, the term “payment device” may refer to an electronic payment device, a portable financial device (e.g., a payment card, such as a credit or debit card), a gift card, a smartcard, smart media, a payroll card, a healthcare card, a wristband, a machine-readable medium containing account information, a keychain device or fob, a radio frequency identification (RFID) transponder, a retailer discount or loyalty card, a cellular phone, an electronic wallet mobile application, a PDA, a pager, a security card, a computing device, an access card, a wireless terminal, a transponder, and/or the like. In some non-limiting embodiments or aspects, the payment device may include volatile or non-volatile memory to store information (e.g., an account identifier, a name of the account holder, and/or the like).

As used herein, a “point-of-sale (POS) device” may refer to one or more devices, which may be used by a merchant to conduct a transaction (e.g., a payment transaction) and/or process a transaction. For example, a POS device may include one or more client devices. Additionally or alternatively, a POS device may include peripheral devices, card readers, scanning devices (e.g., code scanners), Bluetooth® communication receivers, near-field communication (NFC) receivers, RFID receivers, and/or other contactless transceivers or receivers, contact-based receivers, payment terminals, and/or the like. As used herein, a “point-of-sale (POS) system” may refer to one or more client devices and/or peripheral devices used by a merchant to conduct a transaction. For example, a POS system may include one or more POS devices and/or other like devices that may be used to conduct a payment transaction. In some non-limiting embodiments or aspects, a POS system (e.g., a merchant POS system) may include one or more server computers configured to process online payment transactions through webpages, mobile applications, and/or the like.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computer systems operated by or on behalf of a transaction service provider, such as a transaction processing server executing one or more software applications. A transaction processing server may include one or more processors and, in some non-limiting embodiments or aspects, may be operated by or on behalf of a transaction service provider.

As more computational resources may be required to meet the needs for growing computation from different models and customers, the transactions per second (TPS) and/or consumption of a central processing unit (CPU) and memory may vary among machine learning models and customers. In some situations, rate limits and/or computational resource allocations may be uniformly applied to all models and customers through a shared queue, in a distributed platform level, for example, through software platforms, such as Flink, Hadoop, or Spark. In such a situation, only one instance may be used to hold all active models and customers, instead of per model and/or per customer based instances. This may increase risk and complexity, in terms of reliability and continuous integration and continuous delivery (CI/CD). In one example, by initially launching a stateless model with fast response time and high TPS, this may cause a stability issue for a whole distributed platform, which contains other models (e.g., production models, such as models that operate in a real-time or runtime environment and are used for providing inferences based on data in a live situation).

In some scenarios, adjustments in rate limits may cause unfairness and/or performance degradation for some models and customers. For example, adjustments in rate limits may cause unfairness and/or performance degradation with relatively low throughput, but with a tight response time distribution requirement. Additionally, where resource allocation is managed by a software platform, for example, Flink, crashing due to a lack of memory and/or timeout from a component of the software platform, such as a garbage collector (GC), may occur. A reason for this may be that the software platform does not make a connection to a memory management of tasks (e.g., Dedup) with rate limits and TPS, and may be caused by inputs that are larger than a size of available memory.

Further, business logic, priority, dependency, and the models of CPU and memory consumption as compared to TPS may not be specifically provided at a distributed platform level. In some situations, models and/or customers may have different characteristics of TPS, computational resources and memory consumption, service level agreement (SLA), and may be in different stages of a life cycle. With this, cost and budget planning may not be easy to calculate per model and/or based on customers.

Non-limiting embodiments or aspects of the present disclosure are directed to systems, methods, and computer program products for dynamically processing model inference or training requests. In some non-limiting embodiments or aspects, a model management system may include at least one processor configured to receive a plurality of requests from at least one requesting system and create a plurality of instantiations of at least one machine-learning model, for example, based on the plurality of requests and/or service data associated with each requesting system of the plurality of requesting systems. In some non-limiting embodiments or aspects, the at least one processor is further configured to provide, for example, stream, data associated with at least one request of the plurality of requests to each instantiation of the plurality of instantiations and adjust a rate limit for each instantiation of the plurality of instantiations based on the service data associated with at least one requesting system related to a respective instantiation, which results in an adjusted rate limit. In some non-limiting embodiments or aspects, the at least one processor is further configured to process at least one request of the plurality of requests with an instantiation of the plurality of instantiations based on the adjusted rate limit.

In some non-limiting embodiments or aspects, the service data includes at least one parameter of an SLA stored in a data storage device in association with each requesting system. In some non-limiting embodiments or aspects, the at least one parameter includes a reporting frequency. In some non-limiting embodiments or aspects, when adjusting the rate limit for each instantiation of the plurality of instantiations based on the service data associated with the at least one requesting system associated with the instantiation, the at least one processor is configured to adjust the rate limit to a higher or lower rate limit based on the reporting frequency.

In some non-limiting embodiments or aspects, the at least one processor is further configured to determine whether to store the data associated with the at least one request in a hard disk storage unit or in memory based on the service data. In some non-limiting embodiments or aspects, the at least one processor is further configured to store the data associated with the at least one request based on the determination. In some non-limiting embodiments or aspects, when determining whether to store the data associated with the at least one request in the hard disk storage unit or in the memory, the at least one processor is configured to determine whether to store the data associated with the at least one request in the hard disk storage unit or in the memory based on a reporting frequency parameter of the service data, such that a reporting frequency that satisfies a temporal threshold is stored in the hard disk storage unit.

In some non-limiting embodiments or aspects, the at least one machine-learning model comprises a fraud scoring model, and wherein the plurality of requesting systems comprises a plurality of issuer systems. In some non-limiting embodiments or aspects, when receiving the plurality of requests from the plurality of requesting systems, the at least one processor is configured to receive a plurality of inference or training requests from the plurality of requesting systems to be processed using the at least one machine learning model.

In this way, the model management system may provide for dynamically processing model requests (e.g., inference or training requests) with regard to dynamic resource management that is based on previously unknown or unused information in the form of application and business level information, such as a delta of an SLA (dSLA), cross-function level information, such as back log information (e.g., BackLag) for a stream of data, and/or a relationship among multiple metrics (e.g., a relationship between rate limit and backlog, such that a rate limit may increase a back log, but may reduce memory consumption).

Further, the model management system may provide for per model and/or per customer instances that work together for resource sharing (e.g., in real-time), as well as artificial intelligence based resource adjustments using enriched information as mentioned above (e.g., which may be trained based on historical data). In addition, the model management system may be able to evaluate computational resource capacity against an SLA in terms of each instance of model and/or customer, in terms of rate limit, memory, and/or virtual resources (e.g., vCPU) and be able to isolate problems per instance.

For the purpose of illustration, in the following description, while the presently disclosed subject matter is described with respect to systems, methods, and computer program products for dynamically processing model inference or training requests, which may be used in association with inference tasks associated with payment processing of electronic transactions, one skilled in the art will recognize that the disclosed subject matter is not limited to the non-limiting embodiments or aspects disclosed herein. For example, the systems, methods, and computer program products described herein may be used with a wide variety of settings and/or for making determinations (e.g., predictions, classifications, regressions, and/or the like), such as for fraud detection/prevention, authorization, authentication, identification, and/or the like.

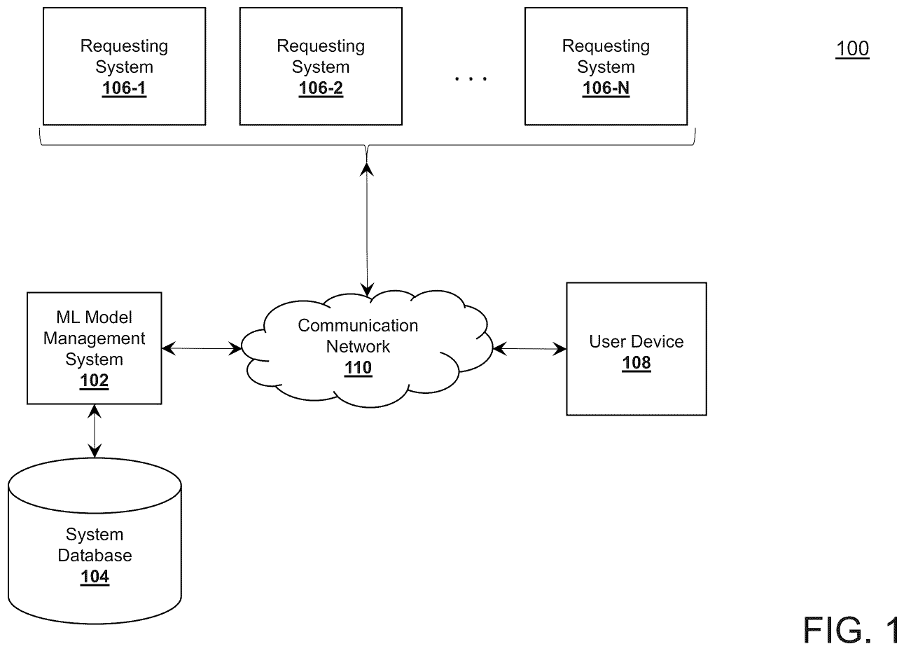

Referring now to FIG. 1, FIG. 1 is a diagram of example system 100 in which devices, systems, and/or methods, described herein, may be implemented. As shown in FIG. 1, system 100 includes machine learning (ML) model management system 102, system database 104, requesting system 106-1 through 106-N (referred to individually as requesting system 106 and collectively as requesting systems 106, where appropriate), user device 108, and communication network 110. ML model management system 102, system database 104, requesting systems 106, and/or user device 108 may interconnect (e.g., establish a connection to communicate) via wired connections, wireless connections, or a combination of wired and wireless connections.

ML model management system 102 may include one or more devices capable of receiving information from and/or communicating information (e.g., directly via wired or wireless communication connection, indirectly via communication network 110, and/or the like) to system database 104, requesting systems 106, and/or user device 108 via communication network 110. For example, ML model management system 102 may include a server, a group of servers, a cloud platform, and/or other like devices. In some non-limiting embodiments or aspects, ML model management system 102 may be associated with a transaction service provider system. For example, ML model management system 102 may be operated by a transaction service provider system. In another example, ML model management system 102 may be a component of user device 108. In another example, ML model management system 102 may include system database 104. In some non-limiting embodiments or aspects, ML model management system 102 may be in communication with a data storage device (e.g., system database 104), which may be local or remote to ML model management system 102. In some non-limiting embodiments or aspects, ML model management system 102 may be capable of receiving information from, storing information in, transmitting information to, and/or searching information stored in the data storage device.

In some non-limiting embodiments, ML model management system 102 may operate (e.g., control, such as by controlling access to computing resources according to at least one rate limit) a computing system (e.g., a cloud computing system, a distributed computing system) based on at least one SLA. For example, ML model management system 102 may operate the computing system based on a plurality of SLAs between an entity (e.g., ML model management system 102, another entity working with ML model management system 102, an entity that operates ML model management system 102, etc.) and requesting systems 106.

In some non-limiting embodiments or aspects, ML model management system 102 may generate (e.g., train, validate, re-train, and/or the like), store, and/or implement (e.g., operate, provide inputs to and/or outputs from, and/or the like) one or more machine learning models. For example, ML model management system 102 may generate one or more machine learning models by fitting (e.g., validating, testing, etc.) one or more machine learning models against data used for training (e.g., training data). In some non-limiting embodiments or aspects, ML model management system 102 may generate, store, and/or implement one or more machine learning models that are provided for a production environment (e.g., a runtime environment, a real-time environment, etc.) used for providing inferences (e.g., secure inferences) based on data inputs in a live situation (e.g., real-time situation, such as a time at which or close to a time at which operations, such as operations of ML model management system 102, are carried out). Additionally or alternatively, ML model management system 102 may generate, store, and/or implement one or more machine learning models that are provided for a non-production environment (e.g., an offline environment, a training environment, etc.) used for providing inferences based on data inputs in a situation that is not live. In some non-limiting embodiments or aspects, ML model management system 102 may be in communication with a data storage device (system database 104), which may be local or remote to ML model management system 102.

System database 104 may include one or more devices capable of receiving information from and/or communicating information (e.g., directly via wired or wireless communication connection, indirectly via communication network 110, and/or the like) to ML model management system 102, requesting systems 106, and/or user device 108 via communication network 110. For example, system database 104 may include a server, a group of servers, a desktop computer, a portable computer, a mobile device, and/or other like devices. In some non-limiting embodiments or aspects, system database 104 may include a data storage device. In some non-limiting embodiments or aspects, system database 104 may be capable of receiving information from, storing information in, communicating information to, or searching information stored in the data storage device. In some non-limiting embodiments or aspects, system database 104 may be part of ML model management system 102 and/or part of the same system as ML model management system 102.

Requesting system 106 may include one or more devices capable of receiving information from and/or communicating information (e.g., directly via wired or wireless communication connection, indirectly via communication network 110, and/or the like) to ML model management system 102, system database 104, and/or user device 108. For example, requesting system 106 may include a computing device, such as a mobile device, a portable computer, a desktop computer, and/or other like devices. Additionally or alternatively, requesting system 106 may include a device capable of receiving information from and/or communicating information to other user devices (e.g., directly via wired or wireless communication connection, indirectly via communication network 110, and/or the like). In some non-limiting embodiments or aspects, requesting system 106 may be part of user device 108 or vice versa. In some non-limiting embodiments or aspects, requesting system 106 may be part of the same system as ML model management system 102. For example, ML model management system 102, system database 104, and/or requesting system 106 may all be (and/or be part of) a single system and/or a single computing device. In some non-limiting embodiments, request system 106 may include an issuer system, an acquirer system, and/or another device or system (e.g., another device or system operated by a financial institution or a financial services provider).

User device 108 may include one or more devices capable of receiving information from and/or communicating information (e.g., directly via wired or wireless communication connection, indirectly via communication network 110, and/or the like) to ML model management system 102, system database 104, and/or requesting systems 106 via communication network 110. For example, user device 108 may include a computing device, such as a mobile device, a portable computer, a desktop computer, and/or other like devices. Additionally or alternatively, user device 108 may include a device capable of receiving information from and/or communicating information to other user devices (e.g., directly via wired or wireless communication connection, indirectly via communication network 110, and/or the like). In some non-limiting embodiments or aspects, user device 108 may be part of ML model management system 102 and/or part of the same system as ML model management system 102. For example, ML model management system 102, system database 104, and user device 108 may all be (and/or be part of) a single system and/or a single computing device.

Communication network 110 may include one or more wired and/or wireless networks. For example, communication network 110 may include a cellular network (e.g., a long-term evolution (LTE) network, a third-generation (3G) network, a fourth-generation (4G) network, a fifth-generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN) and/or the like), a private network, an ad hoc network, an intranet, the Internet, a fiber optic-based network, a cloud computing network, and/or the like, and/or a combination of some or all of these or other types of networks.

The number and arrangement of systems and devices shown in FIG. 1 are provided as an example. There may be additional systems and/or devices, fewer systems and/or devices, different systems and/or devices, and/or differently arranged systems and/or devices than those shown in FIG. 1. Furthermore, two or more systems or devices shown in FIG. 1 may be implemented within a single system or device, or a single system or device shown in FIG. 1 may be implemented as multiple, distributed systems or devices. Additionally or alternatively, a set of systems (e.g., one or more systems) or a set of devices (e.g., one or more devices) of system 100 may perform one or more functions described as being performed by another set of systems or another set of devices of system 100.

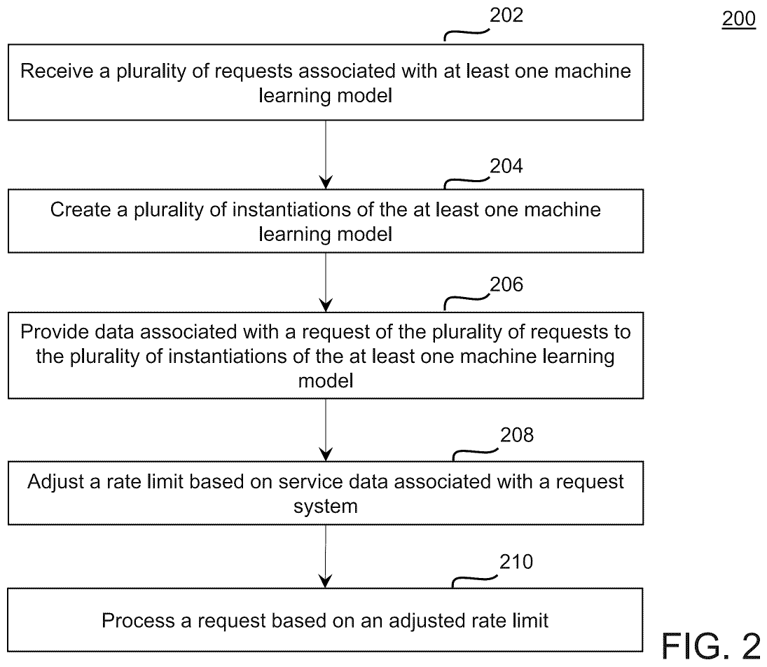

Referring now to FIG. 2, shown is a flow diagram for process 200 for dynamically processing model inference or training requests, according to some non-limiting embodiments or aspects. In some non-limiting embodiments or aspects, one or more of the steps of process 200 may be performed (e.g., completely, partially, etc.) by ML model management system 102 (e.g., one or more devices of ML model management system 102). In some non-limiting embodiments or aspects, one or more of the steps of process 200 may be performed (e.g., completely, partially, etc.) by another device or a group of devices separate from or including ML model management system 102 (e.g., one or more devices of ML model management system 102), system database 104, requesting system 106, and/or user device 108. The steps shown in FIG. 2 are for example purposes only. It will be appreciated that additional, fewer, different, and/or a different order of steps may be used in some non-limiting embodiments or aspects. In some non-limiting embodiments or aspects, a step may be automatically performed in response to performance and/or completion of a prior step.

As shown in FIG. 2, at step 202, process 200 includes receiving a plurality of requests associated with at least one machine learning model. For example, ML model management system 102 may receive the plurality of requests associated with the at least one machine learning model (e.g., one machine learning model, a plurality of machine learning models, at least two machine learning models, etc.) from system database 104, requesting systems 106, user device 108, and/or another system or device. In some non-limiting embodiments or aspects, the machine learning model may include a model for carrying out a task related to electronic payment transactions, such as a fraud scoring model.

In some non-limiting embodiments or aspects, ML model management system 102 may receive a request that includes data associated with the request. In some non-limiting embodiments or aspects, the data associated with the request may include data associated with a task to be carried out with regard to a machine learning model. In some examples, the request may include an inference request (e.g., a request that pertains to performing an inference using a machine learning model, such as a real-time inference) and/or a training request (e.g., a request that pertains to training, including retraining, a machine learning model). In some non-limiting embodiments or aspects, ML model management system 102 may receive the data associated with a task to be carried out with regard to a machine learning model with the request (e.g., included in the request) or ML model management system 102 may receive the data separate from the request (e.g., independent of the request). In some non-limiting embodiments, the data may include a dataset (e.g., a training dataset, a dataset for an inference, such as an inference dataset, etc.).

In some non-limiting embodiments or aspects, the data may be associated with a population of entities (e.g., consumers, requesting systems, users, accountholders, merchants, issuers, etc.) and includes a plurality of data instances associated with a plurality of features (e.g., a plurality of values of features that are to be provided as an input, which may be called input data, to a machine learning model). In some non-limiting embodiments or aspects, the plurality of data instances may represent a plurality of interactions (e.g., transactions, such as electronic payment transactions) conducted that involve the population. In some examples, the data may include a large amount of data instances, such as 100 data instances, 500 data instances, 1,000 data instances, 5,000 data instances, 10,000 data instances, 25,000 data instances, 50,000 data instances, 100,000 data instances, 1,000,000 data instances, and/or the like.

In some non-limiting embodiments or aspects, each data instance may include transaction data associated with the transaction. In some non-limiting embodiments or aspects, the transaction data may include a plurality of transaction parameters associated with an electronic payment transaction. In some non-limiting embodiments or aspects, the plurality of features may represent the plurality of transaction parameters. In some non-limiting embodiments or aspects, the plurality of transaction parameters may include electronic wallet card data associated with an electronic card (e.g., an electronic credit card, an electronic debit card, an electronic loyalty card, and/or the like), decision data associated with a decision (e.g., a decision to approve or deny a transaction authorization request), authorization data associated with an authorization response (e.g., an approved spending limit, an approved transaction value, and/or the like), a PAN, an authorization code (e.g., a personal identification number (PIN), etc.), data associated with a transaction amount (e.g., an approved limit, a transaction value, etc.), data associated with a transaction date and time, data associated with a conversion rate of a currency, data associated with a merchant type (e.g., a merchant category code that indicates a type of goods, such as grocery, fuel, and/or the like), data associated with an acquiring institution country, data associated with an identifier of a country associated with the PAN, data associated with a response code, data associated with a merchant identifier (e.g., a merchant name, a merchant location, and/or the like), data associated with a type of currency corresponding to funds stored in association with the PAN, and/or the like.

In some non-limiting embodiments or aspects, ML model management system 102 may receive the data, which includes data associated with an entity (e.g., data associated with a first entity and/or data associated with a second entity). In some non-limiting embodiments or aspects, the data associated with the entity may include input data (e.g., values of features, such as a feature vector) for a machine learning model that is to be used to perform a task for the entity. Additionally or alternatively, the data associated with the entity may include an identifier of the entity that may be used to instantiate a particular machine learning model (e.g., a particular machine learning model that is configured for a specific purpose, such as fraud detection, transaction authorization, user authentication, user authorization, etc.). Additionally or alternatively, the data associated with the entity may include service data associated with the entity. In such an example, the service data may include data associated with an SLA, which may include specific details of services, provisions of service availability, an outline of responsibilities, escalation procedures, terms for cancellation, and/or the like. Additionally or alternatively, the data associated with an SLA may include application and/or business level information. In some non-limiting embodiments or aspects, each requesting system 106 of requesting systems 106 may have an associated SLA.

In some non-limiting embodiments or aspects, the service data may include at least one parameter of an SLA. In some non-limiting embodiments or aspects, the at least one parameter may include a reporting frequency (e.g., a frequency at which an output of a machine learning model is to be generated for a report to an entity, such as requesting system 106). Additionally or alternatively, the service data may be stored in a data storage device in association with each requesting system 106 of requesting systems 106.

In some non-limiting embodiments or aspects, data associated with a request for a first entity may be the same as or similar to data associated with a request for a second entity (e.g., the data associated with a request for the first entity may include features that are the same as or similar to features included in the data associated with a request for the second entity). In some non-limiting embodiments or aspects, data associated with a request for a first entity may be different from data associated with a request for a second entity (e.g., the data associated with a request for the first entity may include features that are different from features included in the data associated with a request for the second entity).

In some non-limiting embodiments or aspects, ML model management system 102 may determine whether to store the data associated with a request in a hard disk storage unit or in memory. For example, ML model management system 102 may determine whether to store the data associated with a request in a hard disk storage unit or in a memory based on service data. In some non-limiting embodiments or aspects, ML model management system 102 may store the data associated with a request based on the determination. In some non-limiting embodiments or aspects, ML model management system 102 may determine whether to store the data associated with the at least one request in the hard disk storage unit or in the memory based on a reporting frequency parameter of the service data, such that a reporting frequency that satisfies a temporal threshold is stored in the hard disk storage unit.

In some non-limiting embodiments or aspects, requesting system 106 may generate the data associated with a task to be carried out with regard to a machine learning model. For example, requesting system 106 may generate the data associated with a task to be carried out with regard to a machine learning model from a dataset (e.g., a historical dataset). In some non-limiting embodiments or aspects, requesting system 106 may transmit the data associated with a task to be carried out with regard to a machine learning model to ML model management system 102. For example, requesting system 106 may transmit the data to ML model management system 102 based on generating the data, receiving a request for the data from ML model management system 102, based on a predetermined time interval (e.g., a time period associated with a reporting frequency), and/or the like.

As shown in FIG. 2, at step 204, process 200 includes creating a plurality of instantiations of the at least one machine learning model. For example, ML model management system 102 may create (e.g., generate, spool up, activate, etc.) a plurality of instantiations of the at least one machine learning model (e.g., a plurality of instantiations of the same machine learning model, a plurality of instantiations of a plurality of different machine learning models, a plurality of instantiations of a plurality of machine learning models, where at least one machine learning model is different from another machine learning model, etc.) based on receiving a request from requesting system 106. In some non-limiting embodiments or aspects, ML model management system 102 may create the plurality of instantiations based on the plurality of requests (e.g., data included in the plurality of requests) and/or service data associated with at least one (e.g., each, all, at least two, etc.) requesting system 106 of requesting systems 106.

As shown in FIG. 2, at step 206, process 200 includes providing data associated with a request of the plurality of requests to the plurality of instantiations of the at least one machine learning model. For example, ML model management system 102 may provide the data associated with a request to at least one instantiation (e.g., a single instantiation, each instantiation, a group of instantiations, etc.) of the plurality of instantiations of the at least one machine learning model. In some non-limiting embodiments or aspects, ML model management system 102 may stream the data associated with a request to each instantiation of the plurality of instantiations.

For example, ML model management system 102 may stream the data associated with the request to a filter associated with the instantiation, and the filter may provide an output of the data associated with the request that is specific to the instantiation (e.g., an output that is specific to an entity associated with the instantiation, an output specific to a task to be carried out by the instantiation, an output specific to the machine learning model for the instantiation, etc.). In some non-limiting embodiments or aspects, the data associated with the request may be associated with TPS as a measure of an aspect of how the data is streamed. In some non-limiting embodiments or aspects, TPS may refer to a number of atomic actions performed by an entity per second.

In some non-limiting embodiments or aspects, ML model management system 102 may stream the data associated with the request based on a rate limit (e.g., a limit on a rate that requests may be sent and/or received). For example, ML model management system 102 may stream the data associated with the request based on a rate limit associated with an SLA for requesting system 106.

In some non-limiting embodiments or aspects, ML model management system 102 may stream the data associated with the request at a rate limit that is the same for each instantiation of the plurality of instantiations. In some non-limiting embodiments or aspects, ML model management system 102 may stream the data associated with the request at a rate limit for one instantiation of the plurality of instantiations that is different from another instantiation of the plurality of instantiations.

As shown in FIG. 2, at step 208, process 200 includes adjusting a rate limit based on service data associated with a request system. For example, ML model management system 102 may adjust the rate limit based on service data associated with a request system based upon (e.g. based on, after, etc.) providing the data associated with a request of the plurality of requests to the plurality of instantiations. In some non-limiting embodiments or aspects, ML model management system 102 may adjust a rate limit for at least one instantiation of the plurality of instantiations based on the service data associated with requesting system 106 related to a respective instantiation, resulting in an adjusted rate limit. In some non-limiting embodiments or aspects, the adjusted rate limit may include a rate limit that is higher than a prior rate limit or a rate limit that is lower than a prior rate limit. In some non-limiting embodiments or aspects, ML model management system 102 may adjust the rate limit to provide the adjusted rate limit that is a higher rate limit or a lower rate limit based on at least one parameter of an SLA, such as the reporting frequency.

In some non-limiting embodiments or aspects, ML model management system 102 may adjust the rate limit based on a rule based procedure (e.g., a comparison to at least one threshold value), an algorithm based procedure, and/or an artificial intelligence (AI) based procedure (e.g., based on an output from a machine learning model). In one example, ML model management system 102 may adjust the rate limit based on an output of a machine learning model that is configured to receive as an input, a plurality of features. In some non-limiting embodiments or aspects, the output may include a prediction of a rate limit (e.g., a prediction of an adjusted rate limit). In some non-limiting embodiments or aspects, the input may include data associated with TPS, data associated with a back log, data associated with service time (e.g., data associated with an amount of time to complete a task, an amount of time associated with a log event, an amount of time associated with an extract, transfer, and load (ETL) operation), data associated with a delta of an SLA, and/or user inputs (e.g., inputs received from a user program). In some non-limiting embodiments or aspects, the machine learning model may be trained using historical data (e.g., historical data associated with TPS, a back log, service time, a delta of an SLA, a user input, etc.).

As shown in FIG. 2, at step 210, process 200 includes processing a request based on an adjusted rate limit. For example, ML model management system 102 may process at least one request of a plurality of requests with an instantiation of a plurality of instantiations based on the adjusted rate limit.

In some non-limiting embodiments or aspects, ML model management system 102 may perform an action, such as a fraud prevention procedure, a transaction authorization procedure, and/or a recommendation procedure based on the prediction of a relationship between entities. For example, ML model management system 102 may perform the action based on determining to perform the action. In some non-limiting embodiments or aspects, ML model management system 102 may perform a fraud prevention procedure associated with protection of an account of a user (e.g., a first entity, such as a user associated with user device 108) based on an output of a machine learning model. For example, if the output of the machine learning model indicates that the fraud prevention procedure is necessary, ML model management system 102 may perform the fraud prevention procedure associated with protection of the account of the user. In such an example, if the output of the transformer machine learning model indicates that the fraud prevention procedure is not necessary, ML model management system 102 may forego performing the fraud prevention procedure associated with protection of the account of the user.

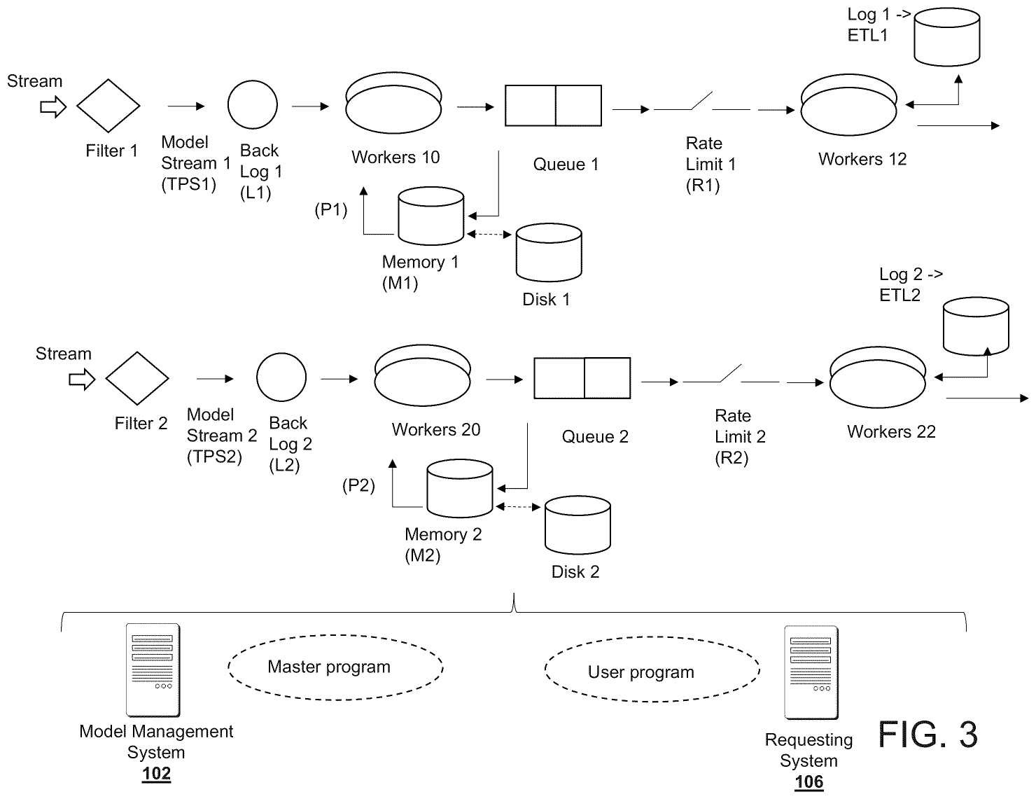

Referring now to FIG. 3, shown is a schematic diagram of implementation 300 of a process (e.g., process 200) for dynamically processing model inference or training requests. In some non-limiting embodiments or aspects, one or more of the steps of the process may be performed (e.g., completely, partially, etc.) by ML model management system 102 (e.g., one or more devices of ML model management system 102). In some non-limiting embodiments or aspects, one or more of the steps of the process may be performed (e.g., completely, partially, etc.) by another device or a group of devices separate from or including ML model management system 102 (e.g., one or more devices of ML model management system 102), system database 104, requesting system 106, and/or user device 108.

As shown in FIG. 3, implementation 300 may include a plurality of instances, including a first instance that includes filter 1, model stream 1, back log 1, workers 10, memory 1, disk 1, queue 1, rate limit 1, workers 12, and log 1 and a second instance that includes filter 2, model stream 2, back log 2, workers 20, memory 2, disk 2, queue 2, rate limit 2, workers 22, and log 2. In some non-limiting embodiments or aspects, the first instance and second instance may be controlled by a master program (e.g., a master program that is operated by ML model management system 102) that performs operations in conjunction with a user program (e.g., a user program that is operated by requesting systems 106, user device 108, another device or system, etc.).

In some non-limiting embodiments or aspects, disk 1 and/or disk 2 may include a hard disk storage unit (e.g., a long term memory storage unit). In some non-limiting embodiments or aspects, memory 1 and/or memory 2 may include a memory component (e.g., a short term memory storage unit for immediate use by a processor, such as RAM, a cache, a main memory, a primary storage unit, etc.).

In some non-limiting embodiments or aspects, the user program and the master program of implementation 300 may work together to create a plurality of instances (e.g., instantiations) in the form of jobs by spawning a group of workers, such as workers 10, 12, 20, and 22 for streaming processes and inference tasks. Execution code for each job may be inserted into filters 1 and 2 and workers 10, 12, 20, and 22. In some non-limiting embodiments or aspects, each instance (e.g., each instance that is created for a job) is fed a subset of stream data that has been filtered. The streaming data, along with data associated with a back log and/or service time, may be used as observing measurements, which are subsequently used as feedback to the master program.

In some non-limiting embodiments or aspects, the first instance and the second instance allow for processing of a stream of data through filter 1 and filter 2 respectively, resulting in model stream 1 and model stream 2. Each of model stream 1 and model stream 2 may be processed by workers 10 and workers 20, respectively, and, for example, in parallel. In some non-limiting embodiments or aspects, workers 10 and workers 20 may operate based on a process-phase callout, and workers 12 and workers 22 may operate based on an inference callout to process model stream 1 and model stream 2, respectively.

In some non-limiting embodiments or aspects, memory 1 and memory 2 and queue 1 and queue 2 (e.g., queue 1 and/or queue 2 may be an intermediate queue) may be utilized to store intermediate results of an operation from each of workers 10 and workers 20, respectively. In some non-limiting embodiments or aspects, the memory, memory 1 and memory 2, and the disk, disk 1 and disk 2, can be used together, or independently, by the master program to offload data from the memory to the disk or vice versa.

In some non-limiting embodiments or aspects, rate limit 1 and rate limit 2 may feed in the intermediate results from queue 1 and queue 2, respectively, for example, in order to reduce the throughput for each. In some non-limiting embodiments or aspects, the master program may be given data associated with model stream 1 and model stream 2, back log 1 and back log 2, and log 1 and log 2 (e.g., log 1 and log 2 may include service time information) as observing measurements for feedback purposes.

In some non-limiting embodiments or aspects, the master program may adjust (e.g., readjust) rate limit 1 and/or rate limit 2; memory 1 and/or memory 2 (e.g., an allocation of memory 1 and/or memory 2); and/or a process-phase callout of workers 10, an inference callout of workers 12, a process-phase callout of workers 20, and/or an inference callout of workers 22, based on the observing measurements. The master program may use data associated with log 1 and/or log 2 and/or inputs from the user program to generate a dSLA. The master program may use data associated with back log 1 and/or back log 2 and/or dSLA as feedback signals. Additionally or alternatively, a measure of virtual resources, memory 1, memory 2, and/or any additional available storage may be used as observing measurements for feedback. In some non-limiting embodiments or aspects, data stored in memory 1 and memory 2 may be offloaded to disk 1 and disk 2, respectively.

In some non-limiting embodiments or aspects, the master program uses the service time and inputs feed in from the user program in order to generate the dSLA. The master program uses observation measurements from back logs and dSLAs as feedback signals. Additionally or alternatively, an amount of virtual resources used, an amount of memory storage used, and/or a total amount of storage available in all instances are used as observation measurements. In some non-limiting embodiments or aspects, the master program may make an adjustment (e.g., re-adjustment) to a rate limit (R1/R2), an allocation of memory (M1/M2), and/or aspects of workers (P1/2, I1/2), for example, in real-time, based on the observation measurements. The adjustment may be rule-based, algorithm-based, or AI-based, and may be applied, along with business logic and human decision. In some non-limiting embodiments or aspects, the adjustment may be set as applicable for a batch and/or stream in terms of a MapReduce and/or Streaming framework. In some non-limiting embodiments or aspects, implementation 300 of FIG. 3 may be applied to the Batch MapReduce (e.g., in Hadoop) processes, where the Batch MapReduce process may utilize ThreadPool management, gRPC, Protobuff, master program and worker management, and/or factory injection for user defined Map-Reduce Tasks. In non-limiting embodiments or aspects, implementation 300 of FIG. 3 may also be utilized for Streaming (Flink), wherein TaskManager is used for managing memory and thread allocation. In some non-limiting embodiments or aspects, implementation 300 may switch from Batch to Streaming, resulting in the priority shift from Harvest to Yield.

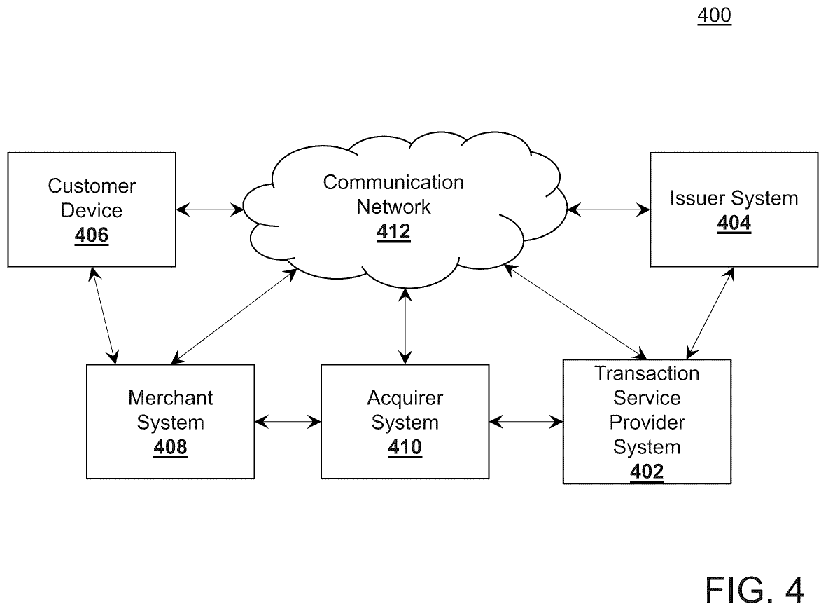

Referring now to FIG. 4, shown is a diagram of a non-limiting embodiment or aspect of exemplary environment 400 in which systems, methods, and/or products, as described herein, may be implemented. As shown in FIG. 4, environment 400 may include transaction service provider system 402, issuer system 404, customer device 406, merchant system 408, acquirer system 410, and communication network 412. In some non-limiting embodiments or aspects, each of ML model management system 102, system database 104, and/or user device 108 of FIG. 1 may be implemented by (e.g., part of) transaction service provider system 402. In some non-limiting embodiments or aspects, at least one of ML model management system 102, system database 104, and/or user device 108 of FIG. 1 may be implemented by (e.g., part of) another system, another device, another group of systems, or another group of devices, separate from or including transaction service provider system 402, such as issuer system 404, customer device 406, merchant system 408, acquirer system 410, and/or the like.

Transaction service provider system 402 may include one or more devices capable of receiving information from and/or communicating information to issuer system 404, customer device 406, merchant system 408, and/or acquirer system 410 via communication network 412. For example, transaction service provider system 402 may include a computing device, such as a server (e.g., a transaction processing server), a group of servers, and/or other like devices. In some non-limiting embodiments or aspects, transaction service provider system 402 may be associated with a transaction service provider, as described herein. In some non-limiting embodiments or aspects, transaction service provider system 402 may be in communication with a data storage device, which may be local or remote to transaction service provider system 402. In some non-limiting embodiments or aspects, transaction service provider system 402 may be capable of receiving information from, storing information in, communicating information to, or searching information stored in the data storage device.

Issuer system 404 may include one or more devices capable of receiving information and/or communicating information to transaction service provider system 402, customer device 406, merchant system 408, and/or acquirer system 410 via communication network 412. For example, issuer system 404 may include a computing device, such as a server, a group of servers, and/or other like devices. In some non-limiting embodiments or aspects, issuer system 404 may be associated with an issuer institution, as described herein. For example, issuer system 404 may be associated with an issuer institution that issued a credit account, debit account, credit card, debit card, and/or the like to a user associated with customer device 406.

Customer device 406 may include one or more devices capable of receiving information from and/or communicating information to transaction service provider system 402, issuer system 404, merchant system 408, and/or acquirer system 410 via communication network 412. Additionally or alternatively, each customer device 406 may include a device capable of receiving information from and/or communicating information to other customer devices 406 via communication network 412, another network (e.g., an ad hoc network, a local network, a private network, a virtual private network, and/or the like), and/or any other suitable communication technique. For example, customer device 406 may include a client device and/or the like. In some non-limiting embodiments or aspects, customer device 406 may or may not be capable of receiving information (e.g., from merchant system 408 or from another customer device 406) via a short-range wireless communication connection (e.g., an NFC communication connection, an RFID communication connection, a Bluetooth® communication connection, a Zigbee® communication connection, and/or the like), and/or communicating information (e.g., to merchant system 408) via a short-range wireless communication connection.

Merchant system 408 may include one or more devices capable of receiving information from and/or communicating information to transaction service provider system 402, issuer system 404, customer device 406, and/or acquirer system 410 via communication network 412. Merchant system 408 may also include a device capable of receiving information from customer device 406 via communication network 412, a communication connection (e.g., an NFC communication connection, an RFID communication connection, a Bluetooth® communication connection, a Zigbee® communication connection, and/or the like) with customer device 406, and/or the like, and/or communicating information to customer device 406 via communication network 412, the communication connection, and/or the like. In some non-limiting embodiments or aspects, merchant system 408 may include a computing device, such as a server, a group of servers, a client device, a group of client devices, and/or other like devices. In some non-limiting embodiments or aspects, merchant system 408 may be associated with a merchant, as described herein. In some non-limiting embodiments or aspects, merchant system 408 may include one or more client devices. For example, merchant system 408 may include a client device that allows a merchant to communicate information to transaction service provider system 402. In some non-limiting embodiments or aspects, merchant system 408 may include one or more devices, such as computers, computer systems, and/or peripheral devices capable of being used by a merchant to conduct a transaction with a user. For example, merchant system 408 may include a POS device and/or a POS system.

Acquirer system 410 may include one or more devices capable of receiving information from and/or communicating information to transaction service provider system 402, issuer system 404, customer device 406, and/or merchant system 408 via communication network 412. For example, acquirer system 410 may include a computing device, a server, a group of servers, and/or the like. In some non-limiting embodiments or aspects, acquirer system 410 may be associated with an acquirer, as described herein.

Communication network 412 may include one or more wired and/or wireless networks. For example, communication network 412 may include a cellular network (e.g., a long-term evolution (LTE) network, a third generation (3G) network, a fourth generation (4G) network, a fifth generation (5G) network, a code division multiple access (CDMA) network, and/or the like), a public land mobile network (PLMN), a local area network (LAN), a wide area network (WAN), a metropolitan area network (MAN), a telephone network (e.g., the public switched telephone network (PSTN)), a private network (e.g., a private network associated with a transaction service provider), an ad hoc network, an intranet, the Internet, a fiber optic-based network, a cloud computing network, and/or the like, and/or a combination of these or other types of networks.

The number and arrangement of systems, devices, and/or networks shown in FIG. 4 are provided as an example. There may be additional systems, devices, and/or networks; fewer systems, devices, and/or networks; different systems, devices, and/or networks; and/or differently arranged systems, devices, and/or networks than those shown in FIG. 4. Furthermore, two or more systems or devices shown in FIG. 4 may be implemented within a single system or device, or a single system or device shown in FIG. 4 may be implemented as multiple, distributed systems or devices. Additionally or alternatively, a set of systems (e.g., one or more systems) or a set of devices (e.g., one or more devices) of environment 400 may perform one or more functions described as being performed by another set of systems or another set of devices of environment 400.

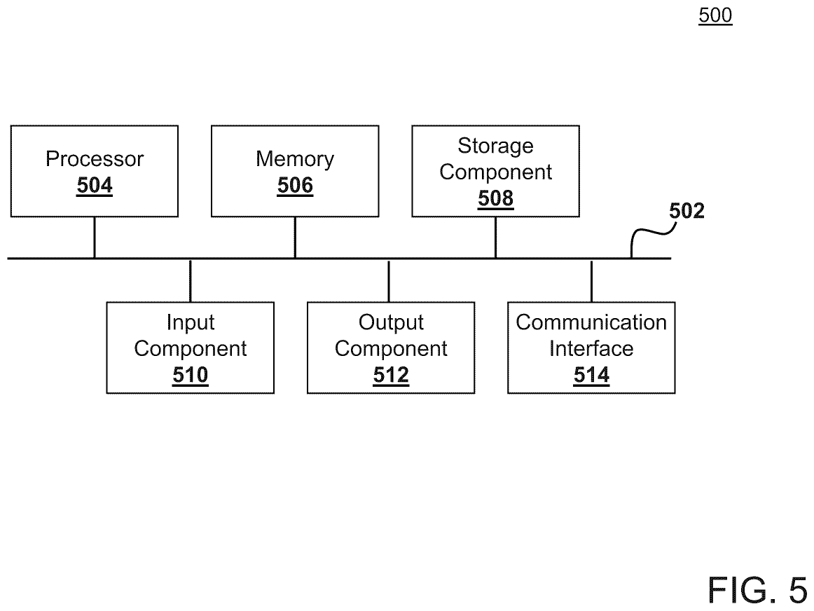

Referring now to FIG. 5, shown is a diagram of example components of device 500, according to non-limiting embodiments or aspects. Device 500 may correspond to at least one of ML model management system 102, system database 104, requesting system 106, and/or user device 108 in FIG. 1 and/or at least one of transaction service provider system 402, issuer system 404, customer device 406, merchant system 408, and/or acquirer system 410 in FIG. 4, as an example. In some non-limiting embodiments or aspects, such systems or devices in FIG. 1 or FIG. 4 may include at least one device 500 and/or at least one component of device 500. The number and arrangement of components shown in FIG. 5 are provided as an example. In some non-limiting embodiments or aspects, device 500 may include additional components, fewer components, different components, or differently arranged components than those shown in FIG. 5. Additionally or alternatively, a set of components (e.g., one or more components) of device 500 may perform one or more functions described as being performed by another set of components of device 500.

As shown in FIG. 5, device 500 may include bus 502, processor 504, memory 506, storage component 508, input component 510, output component 512, and communication interface 514. Bus 502 may include a component that permits communication among the components of device 500. In some non-limiting embodiments or aspects, processor 504 may be implemented in hardware, firmware, or a combination of hardware and software. For example, processor 504 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 506 may include random access memory (RAM), read only memory (ROM), and/or another type of dynamic or static storage device (e.g., flash memory, magnetic memory, optical memory, etc.) that stores information and/or instructions for use by processor 504.

With continued reference to FIG. 5, storage component 508 may store information and/or software related to the operation and use of device 500. For example, storage component 508 may include a hard disk (e.g., a magnetic disk, an optical disk, a magneto-optic disk, a solid-state disk, etc.) and/or another type of computer-readable medium. Input component 510 may include a component that permits device 500 to receive information, such as via user input (e.g., a touch screen display, a keyboard, a keypad, a mouse, a button, a switch, a microphone, etc.). Additionally or alternatively, input component 510 may include a sensor for sensing information (e.g., a global positioning system (GPS) component, an accelerometer, a gyroscope, an actuator, etc.). Output component 512 may include a component that provides output information from device 500 (e.g., a display, a speaker, one or more light-emitting diodes (LEDs), etc.). Communication interface 514 may include a transceiver-like component (e.g., a transceiver, a separate receiver and transmitter, etc.) that enables device 500 to communicate with other devices, such as via a wired connection, a wireless connection, or a combination of wired and wireless connections. Communication interface 514 may permit device 500 to receive information from another device and/or provide information to another device. For example, communication interface 514 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 500 may perform one or more processes described herein. Device 500 may perform these processes based on processor 504 executing software instructions stored by a computer-readable medium, such as memory 506 and/or storage component 508. A computer-readable medium may include any non-transitory memory device. A memory device may include memory space located inside of a single physical storage device or memory space spread across multiple physical storage devices. Software instructions may be read into memory 506 and/or storage component 508 from another computer-readable medium or from another device via communication interface 514. When executed, software instructions stored in memory 506 and/or storage component 508 may cause processor 504 to perform one or more processes described herein. Additionally or alternatively, hardwired circuitry may be used in place of or in combination with software instructions to perform one or more processes described herein. Thus, embodiments described herein are not limited to any specific combination of hardware circuitry and software. The term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

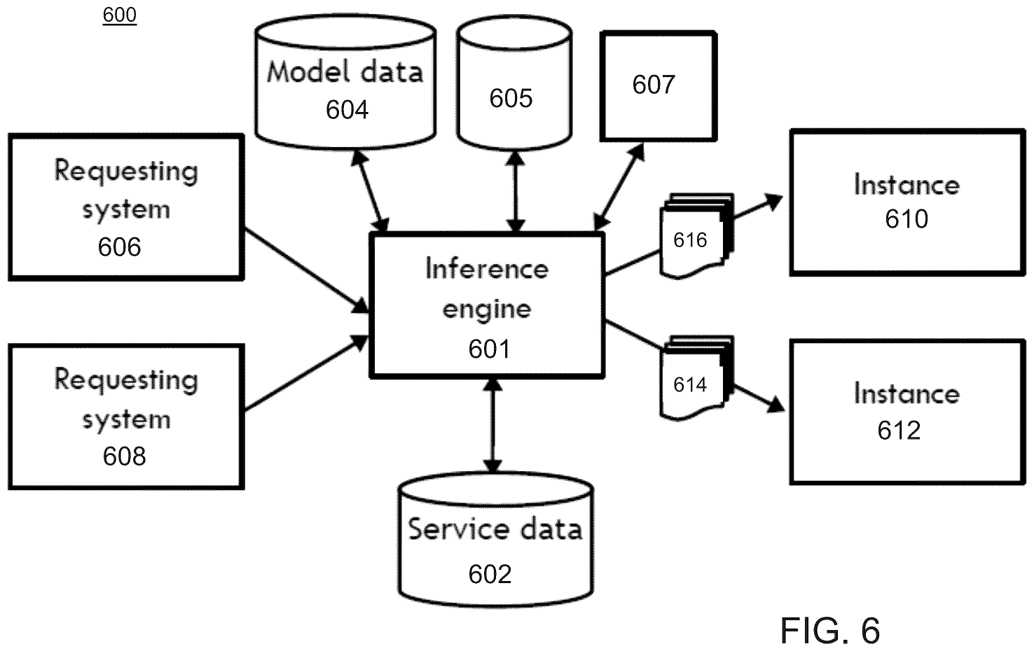

Referring now to FIG. 6, shown is a diagram of system 600 for dynamically processing model inference and training requests, according to some non-limiting embodiments or aspects. As shown in FIG. 6, system 600 may include model data 604, which may include one or more data storage devices having one or more machine learning models stored thereon. In some examples, a machine learning model may be configured to generate predicted classifications for inputs (e.g., transaction data, account data, and/or the like). There may be a plurality of different machine learning models stored as model data 604. The outputs of the model(s) may also be stored as model data 604 and/or may be stored in one or more other data storage devices. System 600 may include service data 602, which may include one or more data storage devices having information relating to one or more SLAs for different systems (e.g., requesting systems 606, 608).

In some non-limiting embodiments or aspects, inference engine 601 may be in communication with model data 604 and service data 602. In some non-limiting embodiments or aspects, inference engine 601 may include one or more computing devices and/or software applications executed by one or more computing devices. In some examples, inference engine 601 may be executed by a server. In some non-limiting embodiments or aspects, inference engine 601 may be the same as or similar to ML model management system 102. In some non-limiting embodiments or aspects, inference engine 601 may be a component of ML model management system 102 or vice versa. Inference engine 601 may be configured to receive inference requests from a plurality of requesting systems 606, 608, analyze the inference requests, and create at least one instance 610, 612 (e.g., instantiations) of a machine learning model (e.g., from model data 604) for each inference request. An instance may be created for each consumer and/or each model, as an example. Inference engine 601 may also coordinate the streaming of input data 614, 616 to each of instances 610, 612. In some non-limiting embodiments or aspects, requesting system 606 and/or requesting system 608 may be the same as or similar to requesting system 106.

In some non-limiting embodiments or aspects, a model training engine (not shown in FIG. 6) may be in communication with model data 604 and service data 602. A model training engine may include one or more computing devices and/or software applications executed by one or more computing devices. In some examples, the model training engine may be executed by a server. The model training engine may be configured to receive model training requests from a plurality of requesting systems 606, 608, analyze the training requests, and train one or more models (e.g., one or more instances 610, 612 of a machine learning model). In non-limiting embodiments or aspects, there may be an instance created for each training request. In some examples, a single software engine may serve as both an inference engine and a model training engine.

In non-limiting embodiments or aspects, requesting systems 606, 608 may include one or more computing devices located remote from inference engine 601. For example, requesting systems 606, 608 may be issuer systems associated with different issuer institutions that send inference or training requests based on transaction data for account holders. In some non-limiting embodiments or aspects, various types of requesting systems may communicate with inference engine 601 and/or a model training engine. Requesting systems 606, 608 may communicate with inference engine 601 or model training engine over one or more network connections. In some examples, inference or training requests may be made through the use of one or more APIs exposed by inference engine 601 or model training engine.

In non-limiting embodiments, inference engine 601 or model training engine may be operated and/or controlled by a transaction processing system of a transaction service provider, although it will be appreciated that other entities may operate and/or control inference engine 601 or model training engine.

In non-limiting embodiments or aspects, service data 602 is used to determine a rate limit for each instance 610, 612. In some examples, requesting system 606 may have an SLA with inference engine 601 (e.g., or an entity that controls or operates inference engine 601) that includes a frequency of reporting (e.g., a frequency of reporting an output of a machine learning model to requesting system 606). The frequency of reporting may be weekly, daily, every 12 hours, every 6 hours, every hour, every 30 minutes, every 10 minutes, in near real-time (e.g., instantaneous), and/or the like. This reporting information (e.g., the output of a machine learning model) may be stored as service data 602 to be queried by inference engine 601 based on receiving inference or training requests from requesting system 606. Based on the reporting frequency associated with requesting system 606, inference engine 601 may create instance 610 and adjust a rate limit of input data (e.g., data stream) 616 to instance 610 based on the reporting frequency. As another example, requesting system 608 may have a different SLA (e.g., an SLA for requesting system 608 that is different from an SLA for requesting system 606) with inference engine 601 (e.g., or an entity that operates inference engine 601) that includes a frequency of reporting that is greater (e.g., more frequent) than the frequency of reporting of service data 602 for requesting system 606. The frequency of reporting regarding the SLA for requesting system 608 may be weekly, daily, every 12 hours, every 6 hours, every hour, every 30 minutes, every 10 minutes, in near real-time (e.g., instantaneous), and/or the like. This reporting information may be stored as service data 602 to be queried by inference engine 601 based on receiving inference or training requests from requesting system 608. Based on the reporting frequency associated with requesting system 608, inference engine 601 may create instance 612 and adjust a rate limit of data stream 614 to instance 612 based on the reporting frequency.

In non-limiting embodiments or aspects, additionally or alternatively to reporting frequency, a rate limit may be based on a current resource availability, historical resource or performance profiling per instance, and/or future resource scheduling per instance. In non-limiting embodiments or aspects, the inference or training requests received from requesting systems 606, 608 may include input data to be used by inference engine 601. The input data may include, for example, account data, transaction data, and/or the like. Such data may be stored in hard disk storage unit 605 and/or memory 607 (e.g., such as RAM or other transient storage). In non-limiting embodiments or aspects, inference engine 601 may determine whether to store the input data in hard disk storage unit 605 or in memory 607 based on service data 602. For example, a reporting frequency parameter of service data 602 for requesting systems 606, 608 may be used to determine where the input data is stored. If the reporting frequency satisfies a threshold (e.g., satisfies a threshold value of time, such as one hour), the input data may be stored in hard disk storage unit 605, whereas a reporting frequency that does not satisfy the threshold is stored in memory 607. In non-limiting embodiments or aspects, virtual resources (e.g., vCores), memory allocation, and papalism (e.g., number of threads) per instance may also be adjusted based on one or more parameters of service data 602. In non-limiting embodiments or aspects, the outputs of log per instance may be saved separately, with different retention and/or security policies (e.g., a time period associated with how long outputs are saved, such as for one year, an identifier associated with who can access it, such as a group_id, etc.).

In some non-limiting embodiments or aspects, dynamic programming for virtual resources (e.g., vCore) with an SLA may be carried out according to the following formula:

$${Peak}_{{vCore}_{DP}} ( k ) = \frac{{L}_{{total}_{jobs}} - x ( k ) - WrapDown [ {v}_{job} [ k ] ]}{{T}_{SLA} - ( k ) - WrapDownTime [ {v}_{job} [ k ] ]}$$

where L_{total_jobs} is the number total jobs for one instance that is to be finished and x(k) is the current finished jobs (e.g., a subset of the total jobs), at time k; k is a time period (e.g., a point in time) starting from a beginning of the instance. In addition, WrapDown[v_{job}[k]] is the wrap down jobs which needed to finish the total jobs and return a virtual resource back to a shared pool, with the speed of process v_{job}[k] at a pipeline (e.g., a streaming pipeline) at time k. Further, T_{SLA} is the defined total time to finish all jobs for the instance as specified by the SLA and WrapDownTime [v_{job}[k]] is an amount of time needed to wrap down all jobs and return the virtual resource back to the shared pool. Peak_{vCore DP}(k) is the peak value of virtual resources, calculated at time k.

In some non-limiting embodiments or aspects, the virtual resources acquired by this instance from the shared pool is a minimum of Peakv_{core}_{_{DP}}(k)*Ratio_{elastic}, and N_vCore_{available}(K) according to the following formula:

$${Peak}_{{vCore}_{acquire}} ( k ) = Min ( {Peak}_{{vCore}_{DP}} ( k ) {Ratio}_{elastic} , \qquad {N\_vCore}_{available} ( k ) )$$

The N_vCore_{available}(k) is a total available virtual resource in a shared pool at time k and Ratio_{elastic} is an elastic ratio >=1, which will maximize utilization of the available virtual resource to finish the total jobs assigned to an instance. The elastic ratio may be provided from a look-up table or may be a ratio based on N_vCore_{available}(k), i.e. larger N_vCore_{available} (k) or larger ratio of

$$\frac{{N\_vCore}_{available} ( k )}{{Peak}_{{vCore}_{DP}} ( k )} .$$

some non-limiting embodiments or aspects, the formula above may be applied to memory allocation and/or virtual resource allocation.

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect.

What is claimed is:

1. A system comprising:
at least one processor configured to:
receive a plurality of requests from a plurality of requesting systems;
create a plurality of instantiations of at least one machine learning model based on the plurality of requests and service data associated with each requesting system of the plurality of requesting systems;
stream data associated with at least one request of the plurality of requests to each instantiation of the plurality of instantiations;
adjust a rate limit for each instantiation of the plurality of instantiations based on the service data associated with at least one requesting system related to a respective instantiation, resulting in an adjusted rate limit; and
process at least one request of the plurality of requests with an instantiation of the plurality of instantiations based on the adjusted rate limit.

2. The system of claim 1, wherein the service data comprises at least one parameter of a service level agreement (SLA) stored in a data storage device in association with each requesting system.

3. The system of claim 2, wherein the at least one parameter comprises a reporting frequency, and
wherein, when adjusting the rate limit for each instantiation of the plurality of instantiations based on the service data associated with the at least one requesting system associated with the instantiation, the at least one processor is configured to:
adjust the rate limit to a higher or a lower rate limit based on the reporting frequency.

4. The system of claim 1, wherein the at least one processor is further configured to:
determine whether to store the data associated with the at least one request in a hard disk storage unit or in a memory based on the service data; and
store the data associated with the at least one request based on the determination.

5. The system of claim 4, wherein, when determining whether to store the data associated with the at least one request in the hard disk storage unit or in the memory, the at least one processor is configured to:
determine whether to store the data associated with the at least one request in the hard disk storage unit or in the memory based on a reporting frequency parameter of the service data, such that a reporting frequency that satisfies a temporal threshold is stored in the hard disk storage unit.

6. The system of claim 1, wherein the at least one machine learning model comprises a fraud scoring model, and wherein the plurality of requesting systems comprises a plurality of issuer systems.

7. The system of claim 1, wherein, when receiving the plurality of requests from the plurality of requesting systems, the at least one processor is configured to:
receive a plurality of inference or training requests from the plurality of requesting systems to be processed using the at least one machine learning model.

8. A computer-implemented method comprising:
receiving, with at least one processor, a plurality of requests from a plurality of requesting systems;
creating, with at least one processor, a plurality of instantiations of at least one machine learning model based on the plurality of requests and service data associated with each requesting system of the plurality of requesting systems;
streaming, with at least one processor, data associated with at least one inference request of the plurality of requests to each instantiation of the plurality of instantiations;
adjusting, with at least one processor, a rate limit for each instantiation of the plurality of instantiations based on the service data associated with at least one requesting system associated with the instantiation, resulting in an adjusted rate limit; and
processing, with at least one processor, at least one request of the plurality of requests with an instantiation of the plurality of instantiations based on the adjusted rate limit.

9. The computer-implemented method of claim 8, wherein the service data comprises at least one parameter of a service level agreement (SLA) stored in a data storage device in association with each requesting system.

10. The computer-implemented method of claim 9, wherein the at least one parameter comprises a reporting frequency, and
wherein adjusting the rate limit for each instantiation of the plurality of instantiations based on the service data associated with the at least one requesting system associated with the instantiation comprises:
adjusting the rate limit to a higher or a lower rate limit based on the reporting frequency.

11. The computer-implemented method of claim 8, further comprising:
determining whether to store the data associated with the at least one request in a hard disk storage unit or in a memory based on the service data; and
storing the data associated with the at least one request based on the determination.

12. The computer-implemented method of claim 11, wherein determining whether to store the data associated with the at least one request in the hard disk storage unit or in the memory comprises:
determining whether to store the data associated with the at least one request in the hard disk storage unit or in the memory based on a reporting frequency parameter of the service data, such that a reporting frequency that satisfies a temporal threshold is stored in the hard disk storage unit.

13. The computer-implemented method of claim 8, wherein the at least one machine learning model comprises a fraud scoring model, and wherein the plurality of requesting systems comprises a plurality of issuer systems.

14. The computer-implemented method of claim 8, wherein receiving the plurality of requests from the plurality of requesting systems comprises:
receiving a plurality of inference or training requests from the plurality of requesting systems to be processed using the at least one machine learning model.

15. A computer program product comprising at least one non-transitory computer-readable medium including program instructions that, when executed by at least one processor, causes the at least one processor to:
receive a plurality of requests from a plurality of requesting systems;
create a plurality of instantiations of at least one machine learning model based on the plurality of requests and service data associated with each requesting system of the plurality of requesting systems;
stream data associated with at least one inference request of the plurality of requests to each instantiation of the plurality of instantiations;
adjust a rate limit for each instantiation of the plurality of instantiations based on the service data associated with at least one requesting system associated with the instantiation, resulting in an adjusted rate limit; and
process at least one request of the plurality of requests with an instantiation of the plurality of instantiations based on the adjusted rate limit.

16. The computer program product of claim 15, wherein the service data comprises at least one parameter of a service level agreement (SLA) stored in a data storage device in association with each requesting system.

17. The computer program product of claim 16, wherein the at least one parameter comprises a reporting frequency, and
wherein, the program instructions that cause the at least one processor to adjust the rate limit for each instantiation of the plurality of instantiations based on the service data associated with the at least one requesting system associated with the instantiation, cause the at least one processor to:
adjust the rate limit to a higher or a lower rate limit based on the reporting frequency.

18. The computer program product of claim 15, wherein the program instructions further cause the at least one processor to:
determine whether to store the data associated with the at least one request in a hard disk storage unit or in a memory based on the service data; and
store the data associated with the at least one request based on the determination.

19. The computer program product of claim 18, wherein, the program instructions that cause the at least one processor to determine whether to store the data associated with the at least one request in the hard disk storage unit or in the memory, cause the at least one processor to:
determine whether to store the data associated with the at least one request in the hard disk storage unit or in the memory based on a reporting frequency parameter of the service data, such that a reporting frequency that satisfies a temporal threshold is stored in the hard disk storage unit.

20. The computer program product of claim 15, wherein the at least one machine learning model comprises a fraud scoring model, and wherein the plurality of requesting systems comprises a plurality of issuer systems.
